(19) United States
(12) Patent Application Publication
(10) Pub. No.: US 2003/0012418 A1
(43) Pub. Date: Jan. 16, 2003

(54) Imaging apparatus for microscope

(75) Inventors: Tomohiro Uchida, Hachioji-shi (JP); Shinji Matsushita, Ome-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/195,269

(22) Filed: Jul. 15, 2002

(30) Foreign Application Priority Data
Jul. 16, 2001 (JP) 2001-215900

(51) Int. Cl. G06K 9/00

(52) U.S. Cl. 382/128

(57) ABSTRACT

There is disclosed an imaging apparatus for a microscope according to the present invention, which records image data of a sample image obtained by the microscope in a recording medium, the apparatus comprising an imaging unit which digitally images the sample image and obtains the image data, an image processing section which processes the image data obtained by the imaging unit, and an image recording section which records the image data processed by the image processing section in the recording medium, wherein the image processing section writes symbol string information over the image data.

### CROSS-REFERENCE TO RELATED APPLICATIONS

This application is based upon and claims the benefit of priority from the prior Japanese Patent Application No. 2001-215900, filed Jul. 16, 2001, the entire contents of which are incorporated herein by reference.

### BACKGROUND OF THE INVENTION

1. Field of the Invention

The present invention relates to an imaging apparatus for a microscope, which images a sample image obtained by the microscope.

2. Description of the Background Art

In recent years, a sample image obtained by a microscope has been imaged mainly with a digital camera in many cases. The sample image (microscope image) imaged by the digital camera is stored as an electronic image file. In this case, it is necessary to record information such as an imaging condition in imaging the microscope image in some form. This is important considering that the imaging is performed on the same imaging condition later. Moreover, when the imaged microscope image is reproduced and observed, it is necessary to grasp not only the image but also the information such as the imaging condition in acquiring the image.

For example, in Jpn. Pat. Appln. KOKAI Publication No. 7-284047, symbol string information such as various imaging conditions is set in a printer apparatus. For the printer apparatus, the symbol string information is written in a caption display area of the image, and printed together with the image. That is, in the printer apparatus, the symbol string information is stored and written in image data. Therefore, when the symbol string information is printed together with the image with a separate printer apparatus, the symbol string information such as various imaging conditions has to be set again in the printer apparatus.

As described above, the image data is not associated or recorded with the symbol string information such as various imaging conditions. Therefore, when a plurality of microscope images are imaged in various microscopy states, an observer has to associate the image data with various imaging conditions or the like. This operation is troublesome for the observer. Moreover, when the symbol string information is printed together with the image, the symbol string information is printed in an outer frame portion of the image. Therefore, the image becomes small with respect to a print sheet, and additionally there is also a restriction in a position in which the symbol string information is printed.

As described above, when the symbol string information such as the imaging conditions is printed together with the image, it has heretofore been necessary to set the symbol string information in the printer apparatus, or to read a set file disposed separately from the image into the printer apparatus. This requires an exclusive-use apparatus, application, and the like. That is, there has not heretofore been an imaging apparatus for a microscope in which the symbol string information such as the imaging conditions can be written on the image.

### BRIEF SUMMARY OF THE INVENTION

An object of the present invention is to provide an imaging apparatus for a microscope, in which symbol string information is written with respect to image data acquired by imaging and thereby the image data can be associated and displayed with the symbol string information without any special apparatus.

According to the present invention, there is provided an imaging apparatus for a microscope, which records image data of a sample image obtained by the microscope in a recording medium, the apparatus comprising: an imaging unit which digitally images the sample image and obtains the image data; an image processing section which processes the image data obtained by the imaging unit; and an image recording section which records the image data processed by the image processing section in the recording medium, wherein the image processing section writes symbol string information over the image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing a whole configuration of a microscope system to which an imaging apparatus for a microscope is applied according to a first embodiment of the present invention.

FIG. 2 is a block diagram showing an inner configuration of a camera head section according to the first embodiment of the present invention.

FIG. 3 is a block diagram showing a configuration of a display section according to the first embodiment of the present invention.

FIG. 4 is a diagram showing a whole configuration of an operation board of an operation section according to the first embodiment of the present invention.

FIG. 5 is a diagram showing a configuration of the operation board of the operation section according to the first embodiment of the present invention in a simplified manner.

FIG. 6 is a diagram showing a configuration of an electric circuit in the operation section according to the first embodiment of the present invention.

FIG. 7 is a flowchart showing an operation procedure of the imaging apparatus for the microscope according to the first embodiment of the present invention.

FIG. 8 is a schematic diagram of imaged image data over which symbol string information is written according to the first embodiment of the present invention.

FIG. 9 is a schematic diagram of the imaged image data over which a plurality of types of the symbol string information are written according to the first embodiment of the present invention.

FIG. 10 is a diagram showing a configuration of the operation board of the operation section according to a third embodiment of the present invention in the simplified manner.

FIG. 11 is a diagram showing a display of a menu screen of the display section according to the third embodiment of the present invention.

FIG. 12 is a schematic diagram of the imaged image data in which the symbol string information is written over a right lower part according to the third embodiment of the present invention.

FIG. 13 is a schematic diagram of the imaged image data in which the symbol string information is written over a right upper part according to the third embodiment of the present invention.

FIG. 14 is a schematic diagram of the imaged image data in which a scale is written over the right lower part according to a fourth embodiment of the present invention.

FIG. 15 is a diagram showing a display of menu functions in the display section according to the fourth embodiment of the present invention.

FIG. 16 is a diagram showing the display of menu functions in the display section according to the fourth embodiment of the present invention.

FIG. 17 is a diagram showing the configuration of the operation section according to a fifth embodiment of the present invention in the simplified manner.

### DETAILED DESCRIPTION OF THE INVENTION

Embodiments of the present invention will be described hereinafter with reference to the drawings.

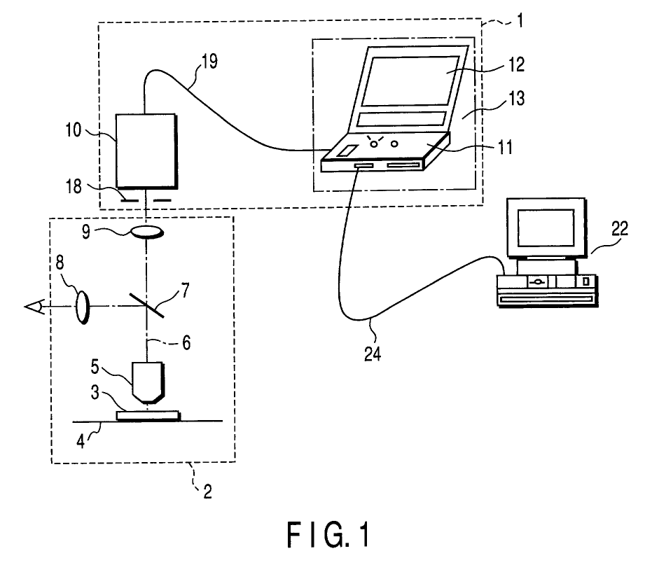

FIG. 1 is a diagram showing a whole configuration of a microscope system to which an imaging apparatus for a microscope is applied according to a first embodiment of the present invention. An imaging apparatus for a microscope (digital camera for the microscope) 1 is mounted on a microscope main body 2. The microscope main body 2 includes: a stage 4 on which a sample 3 is laid; an objective lens 5 for observing the sample 3; a beam splitter 7 disposed on an optical axis 6 of the objective lens 5; an eyepiece lens 8 which is disposed on a reflective optical path of the beam splitter 7 and through which an observer views; an image forming lens 9 disposed on a transmission optical path of the beam splitter 7; and the like.

The imaging apparatus for the microscope 1 includes a camera head section 10 and operation display section 13. The camera head section 10 is connected to the operation display section 13 via a cable 19. The camera head section 10 is disposed on the optical path of a light emitted from the microscope main body 2. The operation display section 13 is configured separately from the camera head section 10 but integrally with an operation section 11 and display section 12. The camera head section 10 is operated from the operation section 11. The display section 12 displays a sample image guided to the camera head section 10, and displays various imaging settings and the like performed in the operation section 11. The operation section 11 of the operation display section 13 is connected to a personal computer (PC) 22 via a communication cable 24.

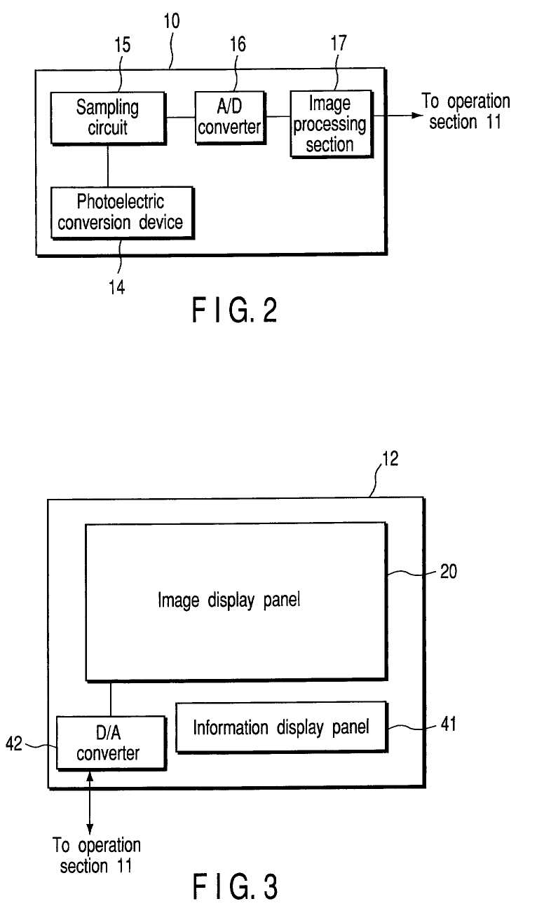

FIG. 2 is a block diagram showing an inner configuration of the camera head section 10. In the camera head section 10, a photoelectric conversion device (charge image forming device) 14 is connected to an image processing section 17 via a sampling circuit 15 and A/D converter 16. The image processing section 17 is connected to the operation section 11. The photoelectric conversion device 14 photoelectrically converts the sample image from the microscope main body 2. The sampling circuit 15 samples the signal based on an electric signal supplied from the photoelectric conversion device 14. The A/D converter 16 converts an analog signal obtained by the sampling circuit 15 into a digital signal. The image processing section 17 subjects the digital signal converted by the A/D converter 16 to a processing for reproducing the image, and obtains imaged image data. Additionally, as shown in FIG. 1, the camera head section 10 includes a shutter 18 to shut off a light image projected on the photoelectric conversion device 14 when desired. For example, a solid-state image sensing device (CCD) is used in the photoelectric conversion device 14.

The camera head section 10 and operation display section 13 mutually transmit/receive the electric signal via the cable 19. Even when the operation display section 13 is disposed apart from the camera head section 10 in a range of a length of the cable 19, an imaging operation by the camera head section 10 is possible. Moreover, the operation section 11 and display section 12 are fixed, while a constant angle is kept. For example, when the operation display section 13 is disposed on a desk, the operation section 11 is substantially horizontal with a desk top surface. The display section 12 has an angle in a range of 0 to 90°, for example, about 90° with respect to the desk top surface so that an observer can easily operate the section. Here, a state of 0° indicates that the operation section 11 and display section 12 are horizontal. That is, various switches such as a mode switch (hereinafter referred to as SW) in the operation section 11 and the image display panel in the display section 12 and the like are disposed on the same surface. Moreover, the external personal computer (hereinafter referred to as PC) 22 is connected to a communication terminal 23 (described later) for outer control disposed in the operation section 11 via the communication cable 24.

FIG. 3 is a block diagram showing a configuration of the display section 12. The display section 12 includes an image display panel 20 and information display panel 41. The image display panel 20 is connected to a D/A converter 42. The D/A converter 42 is connected to the operation section 11. The image display panel 20 displays an imaged image, and a reproduced image of the image data stored in a memory apparatus 26 (described later). The information display panel 41 displays imaging information such as exposure time and exposure correction during the imaging, and reproduction information such as an image file during the reproducing. The D/A converter 42 converts the signal of the imaged image data from a RAM 34 (described later) for display of the operation section 11 into an analog signal necessary for the display.

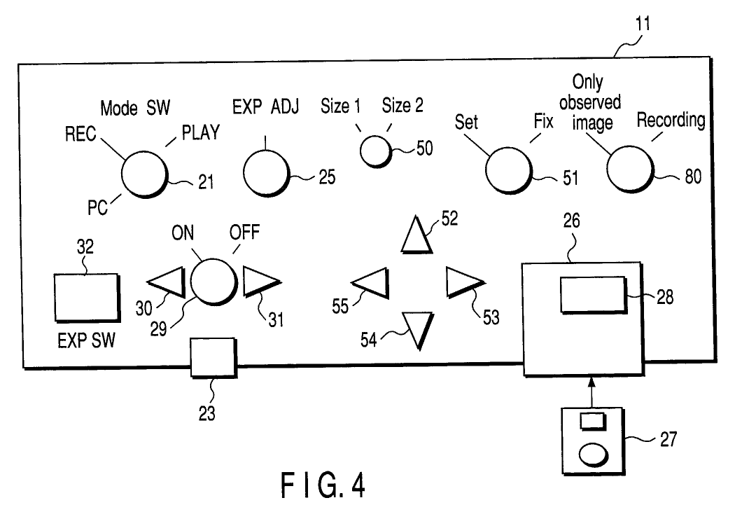

FIG. 4 is a diagram showing a whole configuration of an operation board of the operation section 11. In the operation section 11, there are disposed a mode SW 21, exposure correction SW 25, symbol string control SW 29, left selection SW 30, right selection SW 31, shutter SW (EXPOSE SW) 32, menu SW (MENU SW) 50, positioning SW 51, positioning upper SW 52, positioning right SW 53, positioning lower SW 54, positioning left SW 55, symbol string write mode SW 80, and memory apparatus 26. The operation of the switches of the operation section 11 by the observer is detected by a control circuit 33 (described later). The control circuit 33 performs an operation control described later in response to the operation of the switch.

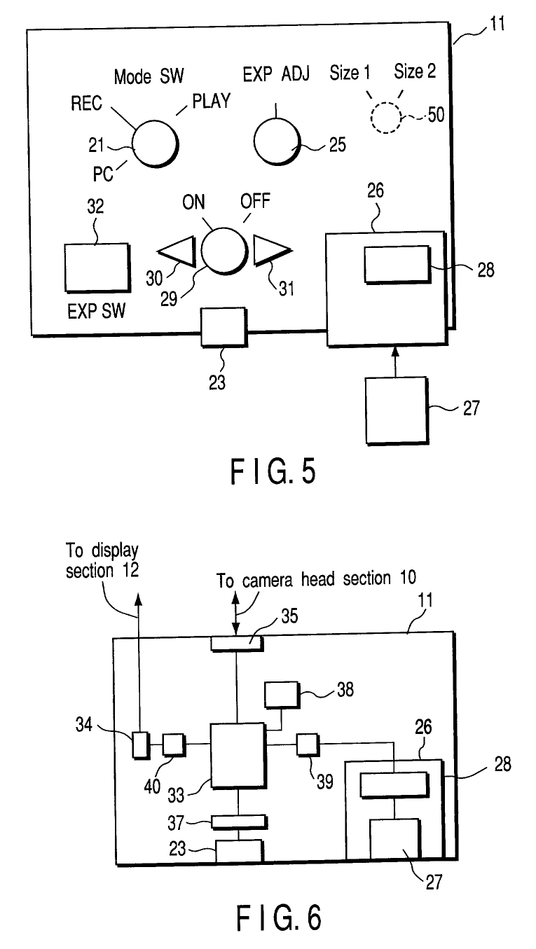

FIG. 5 is a diagram showing a configuration of the operation board of the operation section 11 in a simplified manner to describe the first embodiment. In FIG. 5, the same components as those of FIG. 4 are denoted with the same reference numerals. In the operation section 11, the mode SW 21, exposure correction SW 25, and memory apparatus 26 are disposed. The mode SW 21 selects any one of at least three modes including an “imaging mode” in which the imaging operation is performed, “reproducing mode” in which the imaged image is reproduced, and “PC mode” in which control by the external PC 22 is possible. The exposure correction SW 25 sets an exposure correction value. In the memory apparatus 26, the imaged image is stored. Moreover, in the operation section 11, control switches SW (not shown) for performing various controls with respect to the camera head section 10 and display section 12 are also disposed.

The memory apparatus 26 includes a removal medium 27 and memory read/write section (imaged image recording section) 28. Examples of the removal medium 27 include an attachable/detachable image recording medium such as a floppy disk for broad use, for example, in the external PC 22. The memory read/write section 28 writes/reads the imaged image data (digital image data) with respect to the removal medium 27. Moreover, the operation section 11 includes the communication terminal 23. An access to the memory apparatus 26 or control of various SWs disposed in the operation section 11 are remote-controlled from the external PC 22 or the like via the communication cable 24 and communication terminal 23.

Moreover, in the operation section 11, the symbol string control SW 29, left selection SW 30, right selection SW 31, and shutter SW (EXPOSE SW) 32 are disposed. The symbol string control SW 29 designates the presence/absence of write of the symbol string information into the imaged image data. With the left selection SW 30 and right selection SW 31, the type of the symbol string information to be written is selected. With the shutter SW 32, the imaging is started. Moreover, in the operation section 11, not only the mode SW 21 for setting the mode and the like but also SWs for performing a desired operation with respect to the camera head section 10 and display section 12 are disposed. Thereby, when the observer operates the SWs, the camera head section 10 and display section 12 perform the predetermined operations in response to the operation of the switches.

FIG. 6 is a diagram showing a configuration of an electric circuit in the operation section 11. Various operations of the observer with the operation section 11 are analyzed and processed by the control circuit 33 including a CPU, ROM for storing the program for CPU, RAM and the like. With the display in the display section 12, the control circuit 33 writes the data for the display into the RAM for display 34 via an observed image-symbol string combiner 40. Moreover, with the control concerning the imaging, the control circuit 33 controls the exposure time and the like with respect to the camera head section 10 via a camera head connector 35.

When the imaged image data from the image processing section 17 in the camera head section 10 is recorded in the removal medium 27, the control circuit 33 takes in the imaged image data obtained through the cable 19 via the camera head connector 35. The control circuit 33 processes the imaged image data, and writes the data into the removal medium 27 via an imaged image-symbol string combiner 39 and memory read/write section 28. The communication terminal 23 is connected to the control circuit 33 via a communication section 37, and communication between the external PC 22 and imaging apparatus for the microscope 1 is possible via the communication cable 24.

Further in the operation section 11, the symbol string information is written over the imaged image data by an image processing function of processing the imaged image data. That is, predetermined pixel data in the imaged image data is replaced with the symbol string information by the image processing function. This function is realized by a symbol string ROM 38, and the imaged image-symbol string combiner 39 and observed image-symbol string combiner 40. In the symbol string ROM 38, symbol string font data such as characters, numerals, and various symbols for use in writing the symbol string information in the imaged image data are stored. The imaged image-symbol string combiner 39 combines the imaged image data with the symbol string information. The observed image-symbol string combiner 40 combines observed image data and symbol string information. The operations of the symbol string ROM 38, imaged image-symbol string combiner 39, and observed image-symbol string combiner 40 are controlled by the control circuit 33. Here, examples of the symbol string information include items of imaging conditions such as an imaging date, exposure time, and exposure correction value, and items of microscope conditions such as a microscope name, magnification of the microscope, and microscopy.

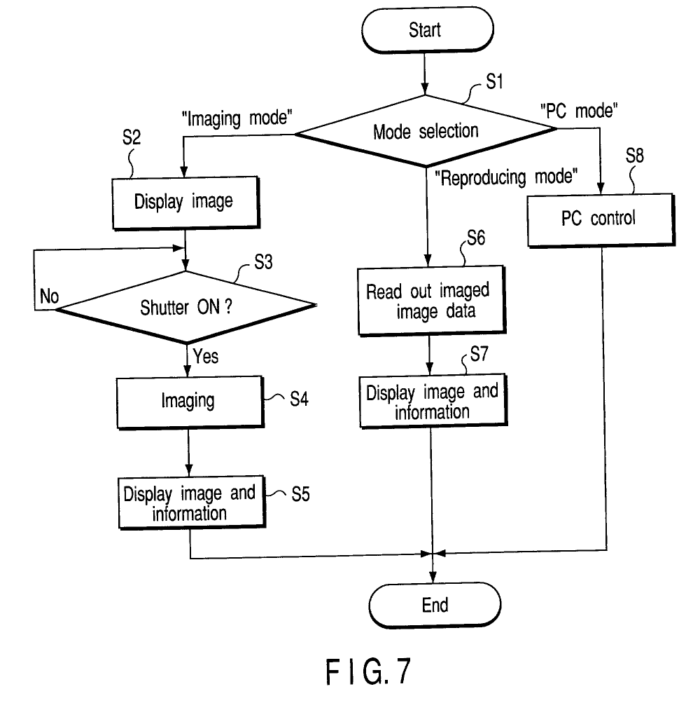

FIG. 7 is a flowchart showing an operation procedure of the imaging apparatus for the microscope configured as described above. An operation of the imaging apparatus for the microscope will be described hereinafter with reference to FIG. 7. The image of the sample 3 of the microscope main body 2 is formed in the photoelectric conversion device 14 of the camera head section 10 via the objective lens 5, beam splitter 7, and image forming lens 9. The sample image is converted to the electric signal indicating the image by the photoelectric conversion device 14 in the camera head section 10. The electric signal is sampled by the sampling circuit 15 in space and time manner, and digitized by the A/D converter 16. Thereafter, the digitized electric signal is subjected to a predetermined image processing based on a sampling component by the image processing section 17, and an imaged image data signal of the reproducible sample 3 is generated. This imaged image data signal is stored in the RAM for display 34 via the cable 19 and the camera head connector 35 and control circuit 33 of the operation section 11. The imaged image data signal stored in the RAM for display 34 is transmitted to the display section 12, converted to the analog signal by the D/A converter 42 shown in FIG. 3, and displayed/outputted into the image display panel 20.

When the image of the sample 3 is displayed in the image display panel 20, the observer can select and set at least an “imaging mode” or “reproducing mode” with the mode SW 21 shown in FIGS. 4, 5. When the observer selects the “imaging mode” (REC) with the mode SW 21 in step S1, an “observation state” is set with respect to the camera head section 10. The camera head section 10 images a moving image of the sample 3 in real time. In step S2, an observed moving image is displayed in the image display panel 20 by the processing of the control circuit 33 in real time. In this case, when the observer turns “ON” the symbol string control SW 29, one desired type of symbol string information selected by the observer with the left selection SW 30 and right selection SW 31 is displayed together with the observed image on the image display panel 20.

In this “observation state”, when the observer depresses the shutter SW 32 in step S3, an “imaging state” is set with respect to the camera head section 10, and the shutter 18 such as a mechanical or electronic shutter opens/closes in accordance with an appropriate exposure time. Thereby, in step S4, the camera head section 10 images a microscope static image of the sample 3 in a stop state. In step S5, the imaged static image is displayed on the image display panel 20, and the symbol string information such as the imaging condition is displayed on the information display panel 41 by the control circuit 33. Additionally, a predetermined time elapses after the shutter SW 32 is depressed. Then, the camera head section 10 images the moving image of the sample 3 in real time, and this observed moving image is displayed in the image display panel 20 by the processing of the control circuit 33 in real time.

Moreover, the imaged image data can be recorded/stored in the removal medium 27 by the memory apparatus 26. In this case, when the symbol string control SW 29 is turned “ON” by the observer, one desired type of symbol string information selected by the observer with the left selection SW 30 and right selection SW 31 is written over the imaged image data. That is, when the observer depresses the shutter SW 32, the control circuit 33 subjects the imaged image data to a predetermined image processing, and reads out the symbol string information selected by the observer from the symbol string ROM 38. Thereafter, the control circuit 33 sends the imaged image data subjected to the image processing and the read symbol string information to the imaged image-symbol string combiner 39. The imaged image-symbol string combiner 39 writes the symbol string information over a designated position of the imaged image data, and sends the information to the memory apparatus 26. In this case, the pixel data in the vicinity of the designated position in the imaged image data is replaced with the symbol string information. The memory read/write section 28 records the imaged image data with the symbol string information written thereon in the removal medium 27.

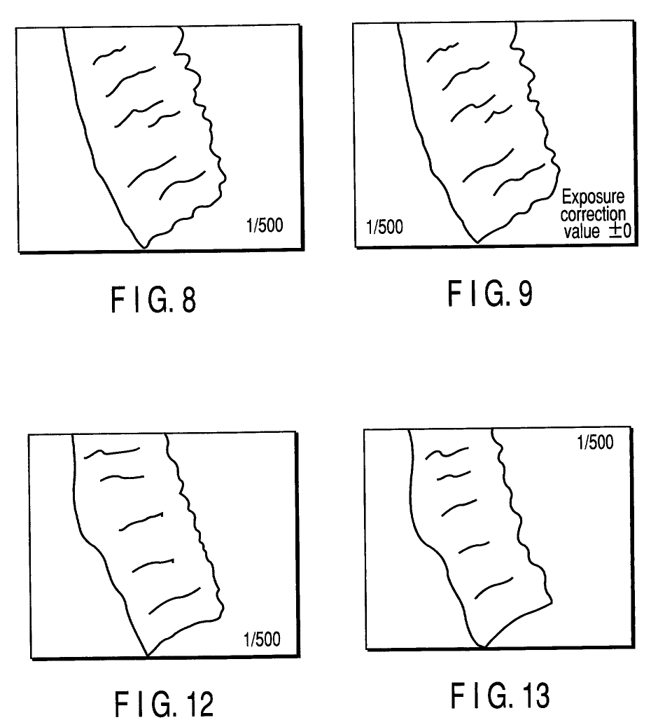

FIG. 8 is a schematic diagram of the imaged image data over which the symbol string information is written. FIG. 8 shows that the imaged image data of the sample 3 including cells is displayed on the image display panel 20. In the imaged image data, the symbol string information (e.g., an exposure time (1/500)) is written over a right lower part. In this manner, the selected symbol string is displayed on the “observation state” image on the image display panel 20. Thereby, the observer can confirm the item of the symbol string information written over the imaged image data. That is, the observed image-symbol string combiner 40 writes the symbol string information over the designated position of the imaged image data from the camera head section 10, and subsequently outputs the imaged image data to the RAM for display 34.

Additionally, when the observer sets the symbol string control SW 29 to be “OFF”, the symbol string information is not written over the imaged image data in the “observation state” on the image display panel 20, or over the imaged image data imaged and recorded in the removal medium 27 when the symbol string control SW 29 is turned “OFF”.

When the observer selects the “reproducing mode” (PLAY) with the mode SW 21 in step S1, the memory read/write section 28 of the memory apparatus 26 reads out the imaged image data recorded in the removal medium 27 in step S6. In step S7, the control circuit 33 takes in the read imaged image data via the imaged image-symbol string combiner 39, and displays the data on the image display panel 20 of the display section 12 via the observed image-symbol string combiner 40 and RAM for display 34. Additionally, the control circuit 33 reads out reproduced image information such as a reproduced file name from the imaged image data, and displays the information on the information display panel 41 of the display section 12 via the observed image-symbol string combiner 40 and RAM for display 34. In this case, the imaged image data over which the symbol string information is written during the imaging is displayed on the image display panel 20. That is, the image imaged by turning “ON” the symbol string control SW 29 is displayed.

When the observer selects a “PC mode” (PC) with the mode SW 21 in the step S1, the operations of the “imaging mode” and “reproducing mode” are controlled by the external PC 22 in step S8. Moreover, the imaged image data stored in the removal medium 27 in the memory apparatus 26 can be stored in a memory apparatus on an external PC 22 side via the imaged image-symbol string combiner 39, control circuit 33, communication section 37, communication terminal 23, and communication cable 24. Furthermore, the imaged image data in the memory apparatus 26 can be displayed on the screen of the external PC 22. Additionally, the content displayed in the display section 12 can be displayed on the screen of the external PC 22. When the imaged image data stored in the removal medium 27 is displayed in the external PC 22, the image is displayed together with the symbol string information written during the imaging. Moreover, even when the image in the “observation state” is displayed in the external PC 22, the image is displayed together with the symbol string information. That is, the image imaged when the symbol string control SW 29 is turned “ON” is displayed.

Moreover, even when the observer removes the removal medium 27 from the imaging apparatus for the microscope 1 and mounts the medium on the external PC 22, and the imaged image data in the removal medium 27 is read out and displayed in the external PC 22, the image is displayed together with the symbol string information written during the imaging.

As described above, in the first embodiment, the items of the imaging conditions such as the imaging date, exposure time, and exposure correction value, and the items of the microscope conditions such as the microscope name, magnification of the microscope, and microscopy are written over the imaged image data acquired by the imaging as the symbol string information. Thereby, only when the image is displayed, the symbol string information can easily be read out. This saves an observer's operation of using the PC application to process the image data.

Moreover, the symbol string information is written on the imaged image data. Therefore, with the apparatus in which the image can be displayed (such as PC, television (TV) monitor, and printer), the symbol string information is displayed on the image and can be read out without any special facilities. For example, when the imaged image data is printed with a plurality of printer apparatuses, the symbol string information is written on the imaged image data, and therefore it is unnecessary to set the symbol string information in each printer apparatus. A relation between the imaged image and the symbol string information can visually and quickly be seen on a printed photograph. For example, even when the imaged image is displayed on the screen of the PC or TV monitor, similarly the relation between the imaged image and the symbol string information can visually and quickly be seen.

Moreover, the symbol string information is written on the imaged image data in a timing before the image recording during the imaging. Therefore, only by the imaging operation, the symbol string information can be written in the imaged image data. This enhances an operating property of the writing/processing of the symbol string information. Furthermore, since the symbol string information written on the imaged image data is set conditions of the microscope main body 2 and imaging apparatus for the microscope 1 during the imaging, an observer's operation of making a note of the set conditions can be saved.

A modification example of the first embodiment will next be described. In the modification example, a plurality of types of symbol string information are written over the imaged image data. Additionally, since the configuration of the imaging apparatus for the microscope is the same as that described in the first embodiment, the detailed description thereof is omitted, and only different respects will be described.

FIG. 9 is a schematic diagram of the imaged image data over which a plurality of types of symbol string information are written. FIG. 9 shows that the imaged image data of the sample 3 including the cell is displayed on the image display panel 20. In the imaged image data, the exposure time (1/500) is written over a left lower part, and the exposure correction value (±0) is written over a right lower part. To overwrite a plurality of types of symbol string information in this manner, the observer selects the symbol string information (exposure time (1/500)) to be displayed in the left lower part on the imaged image data with the left selection SW 30 shown in FIGS. 4, 5, and selects the symbol string information (exposure correction value (±0)) to be displayed in the right lower part on the imaged image data with the right selection SW 31. When the observer depresses the shutter SW 32 in this state, the imaged image data with the plurality of symbol string information written therein as shown in FIG. 9 can be recorded by the processing of the control circuit 33. In this case, since a plurality of types of symbol string information are written in the imaged image data, it is possible to include more symbol string information in the imaged image data.

A second embodiment of the present invention is different from the first embodiment in that a size of the symbol string information is variable in accordance with a pixel size of the imaged image data. Additionally, the description of the same part as that of the first embodiment is omitted, and the different respect will be described.

As shown in FIGS. 4, 5, the menu SW (MENU SW) 50 is disposed in the operation section 11. Here, for the pixel size of the imaged image data recorded in the imaging apparatus for the microscope 1, by the operation of the menu SW 50, the size can selectively be changed, for example, to 640×480 pixels or 1024×768 pixels. The control circuit 33 changes the pixel size of the recorded imaged image data in response to the operation of the menu SW 50, and controls the symbol string information with the changing so that the size of one symbol is changed. For example, when a size “1” of 640×480 pixels is selected, the size of one symbol of the symbol string information is changed to 22×18 pixels by the control circuit 33. Moreover, when a size “2” of 1024×768 pixels is selected, the size of one symbol of the symbol string information is changed to 36×28 pixels.

As described above, in the second embodiment, when the pixel size of the imaged image data is changed in response to the operation of the menu SW 50, the size of one symbol of the symbol string information is changed. This is effective in a case in which the imaged image data is reproduced/displayed on the image display panel 20 or printed in a print sheet, particularly a sheet having a size A6 for frequent use in printing the photograph. That is, when a plurality of imaged image data recorded in different pixel sizes are enlarged/reduced and displayed in an equal size regardless of the pixel sizes, it is possible to display even the overwritten symbol string information in the equal size regardless of the pixel sizes of the recording time.

Thereby, for example, when the recorded imaged image data having a small pixel size is enlarged and printed, the symbol string information is prevented from becoming excessively large. Moreover, when the recorded imaged image data having a large pixel size is reduced and printed, the symbol string information is prevented from becoming excessively small or illegible. Moreover, since the relative sizes of the imaged image data and symbol string information can be unified, the symbol string information can easily be seen.

As described above, according to the second embodiment, the size of the symbol string information written in the imaged image data is variable in accordance with the pixel size of the imaged image data. For example, even when the same symbol string information is written, the symbol string information having a size of 22 (transverse pixels)×18 (vertical pixels) can be written in an image of 640 (transverse pixels)×480 (vertical pixels), and the symbol string information having a size of 36 (transverse pixels)×28 (vertical pixels) can be written in an image of 1024 (transverse pixels)×768 (vertical pixels). Thereby, since the relative sizes of the imaged image data and symbol string information can be unified, the symbol string information can easily be seen.

Moreover, the size of the symbol string information written in the imaged image data changes in accordance with the pixel size of the imaged image data. Therefore, when the size of the image is fixed to the size of a window frame of PC, or the image is printed in the print sheet having the same size, and even when the image is enlarged/reduced at an arbitrary magnification in order to display the whole image, the size of the written symbol string information can be the same. Thereby, even when the image having a large pixel size is reduced/displayed, the written symbol string information has an appropriate size, and can easily be legible.

A modification example of the second embodiment will next be described. In a first modification example, when the “observation state” image can be enlarged/reduced and displayed, or when the “observation state” image can be enlarged/reduced and displayed by a menu operation, the size of the symbol string information is variable. Thereby, when the imaged image data in the “observation state” is displayed on the image display panel 20, a character size of the symbol string information can always be kept at the same size.

For example, when the “observation state” image is displayed in a pixel size of 640×480 pixels on the whole image display panel 20, the pixel size of one symbol of the symbol string information is set to 22×18 pixels. In this state, when the menu SW 50 is operated to display 320×240 pixels out of the pixel size of 640×480 pixels on the whole image display panel 20, that is, when the “observation state” imaged image is enlarged twice and displayed, the pixel size of the symbol string information is changed to 11×9 pixels before the enlargement. Moreover, since the symbol string information is enlarged twice together with the “observation state” image, the pixel size of the symbol string information results in a pixel size of (11×2)×(9×2)=22×18 pixels. Thereby, the pixel size of the displayed symbol string information can be set to be constant regardless of the enlarged/reduced state of the “observation state” image.

In a second modification example, the symbol string information is displayed on the image in the “observation state” by an on screen display (OSD) function. This OSD function comprises: preparing image data for the symbol string with the symbol string information written therein separately from the imaged image data; and overlapping the imaged image data with the image data for the symbol string. In the above-described first and second embodiments and modification examples, the image in the “observation state” and symbol string information are overwritten by the observed image-symbol string combiner 40. In the present modification example, the symbol string information is displayed by the OSD function for use in performing the menu display. In this case, since it is unnecessary to subject the image signal of the “observation state” image to any processing, the observed image-symbol string combiner 40 can be omitted. In this case, the size of one symbol of the symbol string information is set to 22×18 pixels. Moreover, even when the “observation state” image is enlarged/reduced, the size of the symbol string information prepared by the OSD function does not change. Therefore, it is unnecessary to change the size of the symbol string information regardless of the state of the “observation state” image.

A third embodiment of the present invention is different from the first embodiment in that for the display position of the overwritten symbol string information can freely be selected at an arbitrary position in the imaged image. Additionally, the description of the same part as that of the first embodiment is omitted, and the different respect will be described.

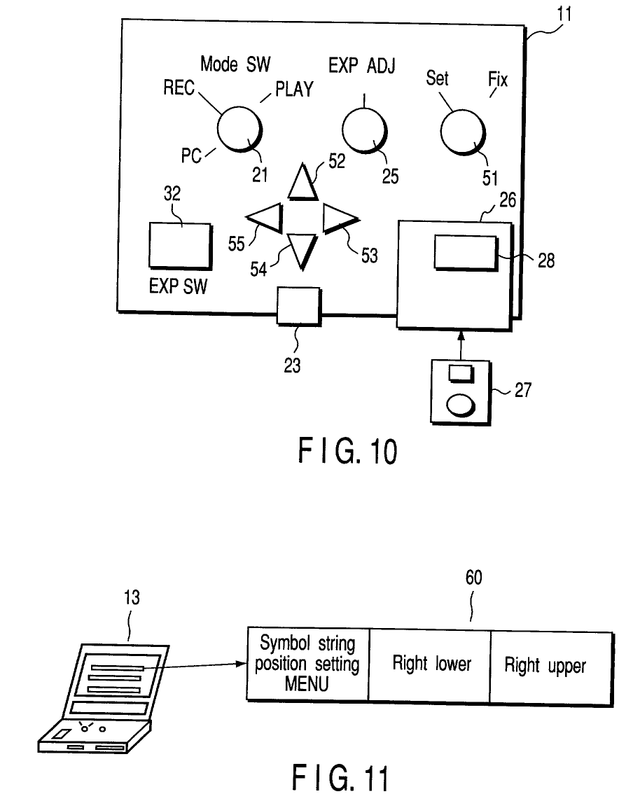

FIG. 10 is a diagram showing a configuration of the operation section 11 in the simplified manner to describe the third embodiment. In FIG. 10, the same components as those of FIG. 4 are denoted with the same reference numerals. In the operation section 11, the positioning SW 51 for selecting that the symbol string information is to be positioned or that it is not to be done, positioning upper SW 52, positioning right SW 53, positioning lower SW 54, and positioning left SW 55 are newly added. The other configuration is similar to FIG. 5. The control circuit 33 performs the processing in response to the operations of the positioning SW 51, positioning upper SW 52, positioning right SW 53, positioning lower SW 54, and positioning left SW 55.

First, in a stage in which the symbol string information to be written is determined, the observer turns the positioning SW 51 to “set”. In this state, the observer finely adjusts the position where the symbol string information is to be written with the positioning upper SW 52, positioning right SW 53, positioning lower SW 54, and positioning left SW 55. In this case, the position of the symbol string information in the “observation state” image on the image display panel 20 can finely be adjusted in accordance with input situations of the positioning upper SW 52, positioning right SW 53, positioning lower SW 54, and positioning left SW 55. Therefore, this fine adjustment is performed while seeing the display on the image display panel 20. Then, the symbol string information can be moved to the desired position on the imaged image. Additionally, the position of the symbol string information in the “observation state” image is a position in which the symbol string information is written over the imaged image.

Subsequently, the observer determines the position where the symbol string information is written, and then turns the positioning SW 51 to “fix”. Thereafter, even when the positioning upper SW 52, positioning right SW 53, positioning lower SW 54, and positioning left SW 55 are depressed, the position of the symbol string information does not change.

As described above, according to the third embodiment, the symbol string information can be disposed in the arbitrary position on the imaged image data, and it is therefore possible to move the symbol string information to a position which does not obstruct the image, or to a noted position. Thereby, the observer can easily observe the image and easily confirm the symbol string information.

A modification example of the third embodiment will next be described. In this modification example, the position where the symbol string information is written is changed in a menu method. In this case, the number of switches disposed in the operation section 11 can be reduced.

FIG. 11 is a diagram showing a display of a menu screen of the display section 12. FIG. 12 is a schematic diagram of the imaged image data in which the symbol string information is written over a right lower part. FIG. 13 is a schematic diagram of the imaged image data in which the symbol string information is written over a right upper part. A menu screen 60 is display in the image display panel 20 as shown in FIG. 11. In the menu screen 60, for example, characters “right lower”, “right upper”, and the like are displayed so that the observer uses the mouse to select and fix the position with the symbol string information to be written therein with a pointer.

With the display of the menu screen 60, it is unnecessary for the observer to position the symbol string information while seeing the “observation state” screen. For example, when “right lower” is selected in FIG. 11, the symbol string information (e.g., exposure time (1/500)) is written over the right lower part of the imaged image data as shown in FIG. 12. Moreover, when “right upper” is selected in FIG. 11, the symbol string information (e.g., exposure time (1/500)) is written over the right upper part of the imaged image data as shown in FIG. 13. In this manner, the position in which the symbol string information is to be written is selected and fixed in the menu screen 60, and therefore a positioning operation is reduced.

In a fourth embodiment of the present invention, a scale (graduation) is used as the symbol string information. This scale depends on a general magnification of the lens in the microscope main body 2 and camera head section 10. The microscope main body 2 includes the objective lens 5, image forming lens 9 and the like, and the camera head section 10 includes a photograph lens and the like. For the respective lenses, the observer can select or change a desired magnification. The general magnification is obtained by multiplying the magnifications of the respective lenses disposed in the microscope main body 2 and camera head section 10. Additionally, the description of the same part as the first embodiment is omitted, and the different respect will be described.

A method of calculating a graduation value of the scale by the general magnification will be described hereinafter. Assuming that a general magnification is N, a scale width ratio to an observation view field (range to be imaged) is Srate, and a size of the observation view field (range to be imaged) is n, a scale graduation value Sval is represented by the following.

Sval=(Srate/N)×n (1)

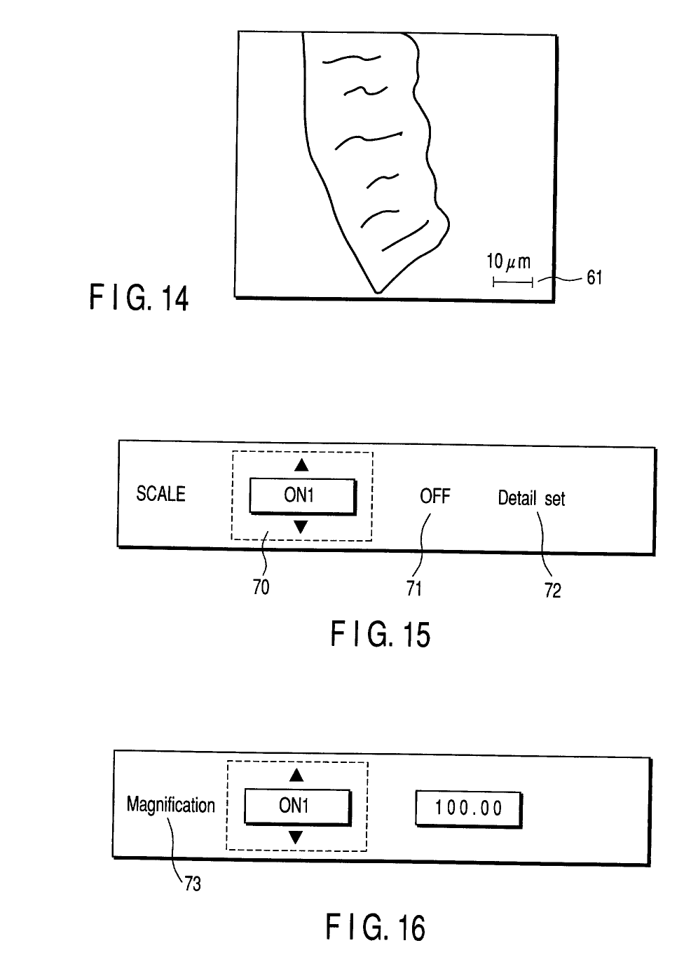

FIG. 14 is a schematic diagram of the imaged image data in which the scale is written as the symbol string information over the right lower part. As shown in FIG. 14, a scale line 61 is written for the scale width ratio Srate in the imaged image data, and a value (e.g., 10 μm) indicated by a scale graduation value Sval is displayed in characters. In this case, the scale width ratio Srate is for three symbols of the symbol string information. For example, when the number of transverse pixels of the imaged image data is 640, the pixel size of one symbol of the symbol string is 22, and the ratio is represented as follows.

Srate=(22×3)/640=0.103 . . .

That is, the scale line 61 is written in the imaged image data with a length of about 10% to the transverse length of the imaged image data. Moreover, when the number of transverse pixels of the imaged image data is 1024, the pixel size of one symbol of the symbol string is 36, and the ratio is represented as follows.

Srate=(36×3)/1024=0.105 . . .

That is, the scale line 61 is written in the imaged image data with a length of about 11% to the transverse length of the imaged image data. In this case, the scale graduation value Sval is determined by the above equation (1). Thereby, the length of an observed portion in the imaged image can easily be measured.

Additionally, assuming that the magnification of the portion related to the microscope main body 2 (magnification of the objective lens 5 in the microscope main body 2) is Nm and the magnification of the portion related to the camera head section 10 (magnification of the camera lens) is Nc, the general magnification N is represented as follows.

N=Nm×Nc (2)

In this case, when the observer inputs a menu item with respect to the general magnification N, the scale graduation value and scale width ratio are calculated by the operation of the control circuit 33, and the scale graduation value and scale line 61 are displayed.

In general, the observer frequently changes the magnification Nm of the microscope, particularly the magnification of the objective lens 5, and performs the microscope observation. Therefore, a plurality of types of general magnifications N can be set and stored in the control circuit 33 by a menu function. Thereby, even when there is a change in the general magnification N by changing the objective lens 5 of the microscope main body 2, but when the stored general magnification N is read out of the menu function, the scale display/write can easily be performed with a correct general magnification N.

FIG. 15 is a diagram showing a display of menu functions in the display section 12. In a scale name selection small item menu 70, the name corresponding to the set general magnification N can be selected. In FIG. 15, “ON1” is selected. In the scale name selection small item menu 70, for example, four scale names “ON1”, “ON2”, “ON3”, and “TEMP” can be selected. A magnification of 100.00 times is set with “ON1”, a magnification of 150.00 times is set with “ON2”, a magnification of 200.00 times is set with “ON3”, and the magnification can be rewritten every “TEMP”. This menu function is also executed by the operation control of the control circuit 33.

When the scale is not displayed/written, “OFF” is selected in a scale OFF small item menu 71. Moreover, when a scale detail set small item menu 72 is selected, a detail menu of scale setting is displayed, for example, as shown in FIG. 16. In a scale magnification setting item 73 in this display, the name indicated in the scale name selection small item menu 70, and the corresponding general magnification N can be inputted using a keyboard or the like. In FIG. 16, 100.00 times is set with respect to “ON1”. In this case, since four scale names “ON1”, “ON2”, “ON3”, and “TEMP” can be selected, the observer can store four general magnifications in the control circuit 33. Additionally, for “TEMP”, when the camera is turned OFF, the information of the general magnification disappears.

On the other hand, for the scale names “ON1”, “ON2”, and “ON3”, the information of the general magnification is held regardless of a power state, until the observer next sets the general magnification again. Thereby, for example, the observer once inputs the general magnifications N corresponding to three objective lenses for frequent use, that is, objective lenses “1”, “2”, and “3” in the scale names “ON1”, “ON2”, and “ON3”, respectively. When the objective lens “2” is used, the scale name selection small item menu 70 is selected from the menu items, and the scale name “ON2” may be selected. Moreover, when the objective lens “3” is used, similarly the scale name “ON3” may be selected in the scale name selection small item menu 70.

Additionally, with “TEMP”, the setting is stored only while the camera is turned ON. Therefore, for example, when the microscope observation is suddenly performed in a combination of general magnifications different from the settings of the scale names “ON1”, “ON2”, and “ON3”, “TEMP” is selected. Thereby, the settings of the scale names “ON1”, “ON2”, and “ON3” for daily use do not have to be destroyed.

As described above, according to the fourth embodiment, the symbol string information written in the imaged image data can be displayed in the scale, and therefore, the length of the observation portion in the imaged image can easily be measured.

A modification example of the fourth embodiment will next be described. In the modification example, a microscope magnification Nm is acquired by the communication. That is, the microscope magnification Nm is acquired, for example, from the microscope main body 2 or the external PC 22 via the communication terminal 23 shown in FIG. 6. In this case, the observer does not have to set the general magnification N including the microscope magnification Nm by the menu items, and a microscopy operation property is enhanced.

Moreover, the general magnification may be set from the microscope magnification Nm acquired by the communication with respect to the scale name “TEMP” of the scale name selection small item menu 70 of the fourth embodiment in the configuration. In this case, it is also possible to select the general magnification from the menu items, and it is further possible to acquire the microscope magnification Nm by the communication. In this case, when there is communicable microscope main body 2 or external PC 22, the microscope magnification Nm is set by the communication. Moreover, when there is not the communicable microscope main body 2 or external PC 22, the magnification can be set by the menu items. Thereby, a variation of scale setting technique increases.

In a fifth embodiment of the present invention, different from the first embodiment, the writing of the symbol string information can be selected so that the information is written only in the imaged image data in the “observation state”, or is also written in the recorded imaged image data. Additionally, the description of the same part as that of the first embodiment is omitted, and the different respect will be described.

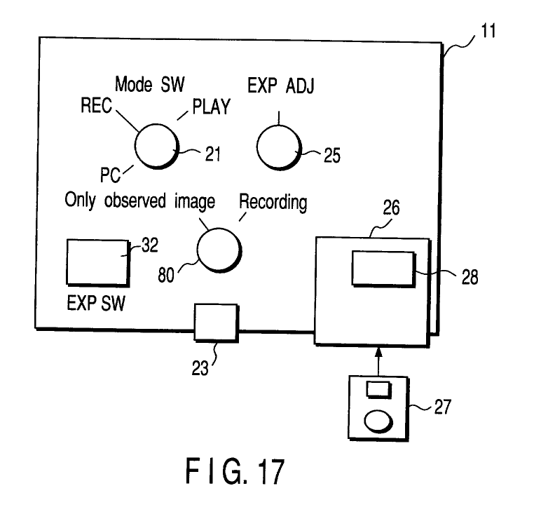

FIG. 17 is a diagram showing the configuration of the operation section 11 in the simplified manner to describe the fifth embodiment. In FIG. 17, the same components as those of FIG. 4 are denoted with the same reference numerals. A symbol string write mode SW80 is disposed in the operation section 11. When an “only observed image” side is selected with this symbol string write mode SW80, the symbol string information is displayed on the “observation state” image in real time. However, even when the imaging operation is performed at this time, the symbol string information is not written over the recorded imaged image data. On the other hand, when a “recording” side is selected with the symbol string write mode SW80, the symbol string information is displayed on the “observation state” image in real time, and the symbol string information is also written over the imaged image data to be recorded. The operation control in response to the selection of the mode SW80 is also performed by the control circuit 33.

As described above, according to the fifth embodiment, it is selected that the symbol string information is or is not written over the imaged image data. Therefore, when it is unnecessary to write the symbol string information, the image can be recorded without writing the symbol string information. Thereby, even when it is unnecessary to write the symbol string information over the imaged image data, it is possible to confirm the symbol string information on the “observation state” image. Moreover, the symbol string information and imaged image data can be compared/confirmed even without performing the imaging, so that the microscopy operation property can be enhanced.

Additionally, the present invention is not limited to the first to fifth embodiments, and can variously be modified without departing from the scope in an implementation stage. For example, in the first to fifth embodiments, among the camera head section 10, operation section 11, and display section 12, the operation section 11 and display section 12 are integrally configured separately from the camera head section 10. However, any other configuration is possible. For example, the camera head section 10 and operation section 11 may integrally be configured separately from the display section 12, or all these components may integrally be configured. Moreover, the attachable/detachable removal medium 27 is used as the image recording medium in the camera in the configuration. However, a recording medium fixed in the memory apparatus 26 may also be used as long as the medium is a nonvolatile memory.

Furthermore, the “imaging mode”, “reproducing mode”, and “PC mode” are changed with the mode SW 21 in the system. At least the “PC mode” is eliminated from the mode SW 21. When the operation section 11 receives an effective external communication signal, an external control mode may be set. In other cases, the operation may also be performed in the “imaging mode” or “reproducing mode”.

As described above in detail, according to the present invention, there can be provided the imaging apparatus for the microscope, in which the symbol string information is written over the image data acquired by the imaging and thereby the image data and the symbol string information can be associated/displayed without any special apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An imaging apparatus for a microscope, which records image data of a sample image obtained by the microscope in a recording medium, the apparatus comprising:
an imaging unit which digitally images said sample image and obtains the image data;
an image processing section which processes the image data obtained by said imaging unit; and
an image recording section which records the image data processed by said image processing section in said recording medium,
wherein said image processing section writes symbol string information over said image data.

2. The imaging apparatus for the microscope according to claim 1, wherein said microscope includes at least an objective lens and image forming lens.

3. The imaging apparatus for the microscope according to claim 1, wherein said image processing section replaces predetermined pixel data in said image data with said symbol string information.

4. The imaging apparatus for the microscope according to claim 1, further comprising: a mode setting section to set a mode such that the imaging is performed by said imaging unit,
wherein said image processing section writes said symbol string information over the image data obtained by said imaging unit in accordance with an imaging setting in said mode setting section, and said image recording section records the image data over which said symbol string information is written in said recording medium.

5. The imaging apparatus for the microscope according to claim 1, further comprising: a symbol string control setting section to set whether or not said image processing section writes said symbol string information over the image data obtained by said imaging unit.

6. The imaging apparatus for the microscope according to claim 5, further comprising: a positioning section to set a position of the image data obtained by said imaging unit, over which said symbol string information is to be written.

7. The imaging apparatus for the microscope according to claim 1, wherein said symbol string information is an imaging condition of a time at which said sample image is imaged.

8. The imaging apparatus for the microscope according to claim 7, further comprising: a symbol string selection section which selects said symbol string information.

9. The imaging apparatus for the microscope according to claim 1, wherein said symbol string information is a scale corresponding to said sample image.

10. The imaging apparatus for the microscope according to claim 9, wherein said scale is represented based on a general magnification of lenses in said microscope and imaging unit.

11. The imaging apparatus for the microscope according to claim 10, further comprising: a scale selection section which selects said scale corresponding to said general magnification.

12. The imaging apparatus for the microscope according to claim 1, wherein said image processing section changes a size of said symbol string information to be written over said image data in accordance with a pixel size of said image data.

13. The imaging apparatus for the microscope according to claim 1, further comprising: a symbol string write mode selection section to select that said symbol string information is displayed only on an observed image of a real time, or that it is displayed on said observed image and written over said image data.

14. An imaging apparatus for a microscope, which records image data of a sample image obtained by the microscope in a recording medium, the apparatus comprising:
an imaging unit which digitally images said sample image and obtains the image data;
an image processing section which processes the image data obtained by said imaging unit; and
an image recording section which records the image data processed by said image processing section in said recording medium,
wherein said image processing section writes symbol string information including an imaging condition of a time at which said sample image is imaged over said image data.

15. An imaging apparatus for a microscope, which records image data of a sample image obtained by the microscope in a recording medium, the apparatus comprising:
an imaging unit which digitally images said sample image and obtains the image data;
an image processing section which processes the image data obtained by said imaging unit; and
an image recording section which records the image data processed by said image processing section in said recording medium,
wherein said image processing section writes symbol string information including a scale corresponding to said sample image over said image data.
